(19) United States
(12) Patent Application Publication
(10) Pub. No.: US 2011/0018307 A1
(43) Pub. Date: Jan. 27, 2011

(54) Drive Unit for a Wind Stop Device

(75) Inventors: Bernhard Rimmelspacher, Rheinstetten (DE); Joerg Riehle, Asperg (DE)

Correspondence Address: REINHART BOERNER VAN DEUREN P.C., 2215 PERRYGREEN WAY, ROCKFORD, IL, 61107, US

(73) Assignee: SCAMBIA INDUSTRIAL DEVELOPMENTS AKTIENGESELLSCHAFT, Schaan (LI)

(21) Appl. No.: 12/839,702

(22) Filed: Jul. 20, 2010

(30) Foreign Application Priority Data
Jul. 21, 2009 (DE) 10 2009 035 335.6

(51) Int. Cl. B60J 1/20

(52) U.S. Cl. 296/180.5

(57) ABSTRACT

In order to improve a drive unit for a wind stop device for convertible vehicles, comprising a base part which can be mounted on a vehicle body and a wind blocker which can be pivoted relative to the base part between an active upright position and an inactive position folded towards the back, wherein the drive unit serves the purpose of pivoting the wind blocker between the active position and the inactive position, in such a manner that it can be fitted to the wind stop device without any alteration to the constructional design of the wind stop device it is suggested that the drive unit comprise a displacing device and a displacing element which is tensilely rigid in its direction of extension and movable transversely to the direction of extension and which couples the displacing device to the wind blocker for pivoting the wind blocker between the active position and the inactive position and, for this purpose, has a section extending in a curved manner at least in one position of the wind blocker.

### CROSS-REFERENCE TO RELATED PATENT APPLICATIONS

This patent application claims the benefit of German application No. 10 2009 035 335.6, filed Jul. 21, 2009, the teachings and disclosure of which are hereby incorporated in their entirety by reference thereto.

### BACKGROUND OF THE INVENTION

The invention relates to a drive unit for a wind stop device for convertible vehicles, comprising a base part which can be mounted on a vehicle body and a wind blocker which can be pivoted relative to the base part between an active upright position and an inactive position folded towards the back, wherein the drive unit serves the purpose of pivoting the wind blocker between the active and the inactive position.

Drive units of this type are known from the state of the art; they are, for example, integrated into the base part in accordance with, for example, EP 1 621 386 A.

Such a drive unit has the disadvantage that it cannot be fitted at a later date and also the additional disadvantage that it makes an alteration in the construction of the wind stop device necessary.

The object underlying the invention is, therefore, to improve a drive unit of the generic type in such a manner that it can be fitted to the wind stop device without any alteration to the constructional design of the wind stop device.

### SUMMARY OF THE INVENTION

This object is accomplished in accordance with the invention, in a drive unit of the type described at the outset, in that the drive unit comprises a displacing device and a displacing element which is tensilely rigid in its direction of extension and can be moved transversely to the direction of extension and which couples the displacing device to the wind blocker for pivoting the wind blocker between the active and the inactive position and for this purpose has a section extending in a curved manner at least in one position of the wind blocker.

The advantage of the solution according to the invention is to be seen in the fact that, with it, it is possible to mount the drive unit in a simple manner since the displacing element can extend in a straight alignment or in a curved manner transversely to its direction of extension and, therefore, can engage on the wind blocker in a manner which makes an alteration in the course of the displacing element necessary during the transition from one position to the other.

As a result, the drive unit according to the invention can be mounted with the displacing element such that this can adapt to the movement of the wind blocker during its pivoting from the one position into the other position.

The displacing element can, in principle, be designed as an element which can be moved transversely to its direction of extension in a flexurally slack manner.

However, only pulling forces can be transferred with such a displacing element.

For this reason, it is particularly advantageous when the displacing element is designed as an element which can be moved transversely to its direction of extension in a spring elastic manner, wherein the displacing element has a limited inherent rigidity which can be overcome in a spring elastic manner so that pushing forces can also be transferred with the displacing element, at least to a limited extent.

In principle, the displacing element could be designed from the most varied of materials.

One particularly advantageous solution provides for the displacing element to be designed as a strand of metal, for example, as a strip of spring steel since, in this case, a large tensile rigidity is linked to an adequately large inherent rigidity and spring elasticity transversely to the direction of extension, which is required for the transfer of pulling and pushing forces.

For example, the drive unit could be designed such that the displacing element does not engage directly on the wind blocker but rather, for example, on an intermediate element which can be mounted on the wind blocker and could act on the wind blocker in the manner of a lever.

For reasons of as optimum an optical appearance as possible, it has, however, proven to be advantageous when the displacing element can be connected directly to the wind blocker.

It is particularly favorable in this case when the displacing element can be connected to a lower frame bar of a wind blocker frame of the wind blocker.

With respect to the course of the displacing element from the displacing device to the wind blocker, no further details have so far been given.

In principle, it could be provided for the displacing element to extend between the displacing device and the wind blocker frame in an exposed manner.

However, in order to be able to determine the forces acting on the wind blocker element by the displacing element by way of a suitable course of the displacing element at least in a certain area, it is preferably provided for the section of the displacing element extending in a curved manner to be guided by means of a guide.

Such a guide accommodating the curved section of the displacing element allows, on the one hand, the curved section of the displacing element to be designed such that it acts in a pulling manner on the wind blocker in a suitable manner when pulling forces are to be applied to the wind blocker and/or alternatively thereto that pushing forces may also be applied to the wind blocker with the displacing element over and beyond the curved section.

The section of the displacing element extending in a curved manner is guided in a simple manner by the guide in that this has a guide channel extending in a curved manner.

The guide channel could be designed, for example, such that it guides the displacing element exactly and, therefore, predetermines the curved course exactly.

However, in order to be able to utilize the advantages of a displacing element which can be moved transversely to its direction of extension and can be moved, in particular, in a spring elastic manner, it is preferably provided for the guide channel to permit varying curvatures of the section of the displacing element guided in it.

This means that the guide channel allows the movements of the displacing element transversely to its direction of extension which are necessary to follow the movements of the wind blocker during its pivoting from the one position into the other position.

In this respect, it is favorable, in particular, when the guide channel has a funnel-shaped area which permits movement of the displacing element transversely to its direction of extension.

Such a funnel-shaped area of the guide channel is preferably located close to an opening of the guide, from which the displacing element guided to the wind blocker exits.

Furthermore, it is of advantage for the guidance of the displacing element when the guide channel has a curved guiding surface on at least one side since such a curved guiding surface offers the possibility, in a simple manner, of guiding the displacing element in the form of a section extending in a curved manner.

In this respect, it is favorable, in particular, when the displacing element abuts on the curved guiding surface over a greater length when the wind blocker is in the one position than in the other position of the wind blocker, i.e., when the displacing element can abut selectively on the curved guiding surface over different lengths so that the guiding element can, as a result, follow the kinematic movements of the wind blocker during its pivoting from the one position into the other position in a simple manner.

One particularly favorable solution provides for the guide channel to have a curved outer guiding surface and a curved inner guiding surface, between which the displacing element is located.

In this respect, the curved inner guiding surface and the curved outer guiding surface are preferably designed such that they have different courses and so a free space is formed between these curved inner and outer guiding surfaces which results in the displacing element being able to abut selectively on the one curved guiding surface or the other curved guiding surface.

The funnel-like area of the guide channel is preferably located between the two curved guiding surfaces.

Such a design of the guide channel allows the displacing element to be guided, on the one hand, such that it can transfer pulling forces in an optimum manner and, in this respect, abuts on one of the guiding surfaces and can also transfer pushing forces in an optimum manner, at least within the scope of its inherent rigidity, wherein, in this case, the guiding element preferably abuts on the other guiding surface located opposite.

An “inner guiding surface” is to be understood as the guiding surface which is located on an inner side of the arc in the curved section of the displacing element while an outer guiding surface is to be understood as the guiding surface which is located on an outer side of the arc in the curved section.

In order to be able to accommodate the displacing element, in particular, exactly proceeding from the displacing device, it is preferably provided for the guide to have a guide channel with an area guiding the displacing element free from transverse movement.

With respect to the design of the displacing device itself, no further details have so far been given.

For example, the displacing device could be designed as a displacing device which can be driven linearly, wherein this would make a motor drive more difficult.

For this reason, it is preferably provided for the displacing device to comprise a displacing unit which can be driven for rotation and is, therefore, in a position to displace the displacing element with a rotating drive movement.

One advantageous solution provides for the displacing unit which can be driven for rotation to act linearly on the displacing element.

Such a linear action on the displacing element may be realized particularly favorably when the displacing unit comprises a threaded spindle and a spindle nut.

For example, the threaded spindle could be drivable manually.

It is, however, particularly favorable when the threaded spindle can be driven by a drive motor.

In this case, the spindle nut is then arranged so as to be non-rotatable but linearly displaceable.

However, the kinematic reversal is also conceivable, namely that the spindle nut can be driven for rotation and the threaded spindle is arranged so as to be non-rotatable but linearly displaceable.

With respect to the mounting of the drive unit according to the invention, no further details have been given in conjunction with the preceding description of the individual embodiments.

In principle, it could be conceivable to arrange or mount the drive unit on the body of the vehicle.

One particularly advantageous solution provides, however, for the drive unit to be mountable on the base part.

In this respect, it is particularly expedient when the drive unit has a housing which can be mounted on the base part, wherein the housing is preferably mounted such that the housing is adapted to the base part and does not require any alterations to the geometric shape of the base part.

In this respect, it is particularly advantageous when the housing can be mounted on a front part of the base part.

Since the position of the guide relative to the wind stop device and the base part is of significance, it is preferably provided for the housing to be mounted on the base part with a part accommodating the guide so that the part of the housing accommodating the guide is fixed securely to the base part and, therefore, is also in a position to transfer the forces acting primarily on it to the base part.

One particularly favorable solution provides for the housing to engage partially around a front bar of the base part and, therefore, to be fixed to it with this area partially engaging around the bar.

With respect to the arrangement of the guide in the housing relative to the base part, it is particularly favorable when the guide guides the displacing element partially around the front bar of the base part so that, as a result, the displacing element can be guided from the displacing device to the wind blocker in a simple manner, in particular in an optically inconspicuous manner.

With respect to the way, in which the drive unit is mounted on the base part, no further details have likewise been given thus far.

One advantageous solution, for example, provides for the drive unit to be mountable on an underside of the base part.

This solution has the advantage that, as a result, the drive unit is inconspicuous optically for anyone looking at the wind stop device since the drive unit is arranged on the underside of the base part, i.e., on the side of the base part facing the vehicle body and, therefore, is not noticeable optically.

It is particularly favorable when the housing can be mounted on a front bar of the base part from below.

In addition, the invention also relates to a wind stop device for convertible vehicles, comprising a base part which can be mounted on a vehicle body, a wind blocker which can be pivoted relative to the base part between an active upright position and an inactive position folded towards the back as well as a drive unit for pivoting the wind blocker between the active position and the inactive position, wherein, in accordance with the invention, the drive unit is designed in accordance with one or several of the features described above.

Such a wind stop device has the advantages already explained above in conjunction with the drive unit.

Additional features and advantages of the invention are the subject matter of the following drawings as well as the description of one embodiment of a wind stop device according to the invention with a drive unit mounted thereon.

### BRIEF DESCRIPTION OF THE DRAWINGS

FIG. 1 shows a schematic side view of a convertible vehicle with a wind stop device according to the invention;

FIG. 2 shows a perspective illustration of the wind stop device according to FIG. 1 with a drive unit according to the invention;

FIG. 3 shows a side view of the wind stop device according to the invention in an inactive position of the wind blocker;

FIG. 4 shows a section along line 4-4 with a wind blocker partially illustrated by solid lines in the inactive position and a wind blocker partially illustrated by dashed lines in the active position and

FIG. 5 shows a perspective illustration of the wind blocker according to FIG. 2 with a schematic allocation of operating possibilities for operating the drive unit according to the invention.

### DETAILED DESCRIPTION OF THE INVENTION

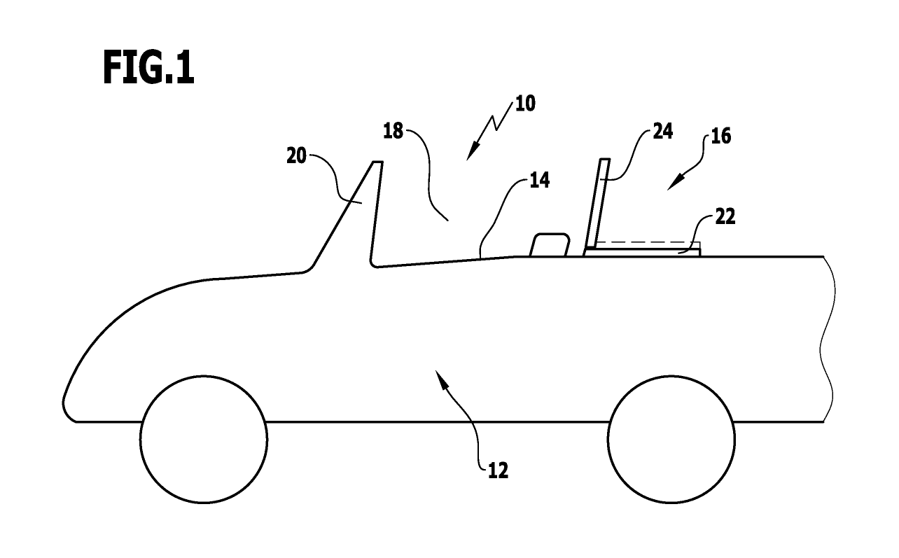

A convertible vehicle, which is illustrated in FIG. 1 and designated as a whole as 10, comprises a vehicle body 12, on which a wind stop device, which is designated as a whole as 16, can be mounted at the level of a belt line 14, namely behind a passenger compartment 18 which is arranged, for its part, behind a windshield 20 of the vehicle body 12.

The wind stop device 16 comprises a base part 22 which can be fixed in position on the vehicle body 12 approximately at the level of the belt line 14 as well as a wind blocker 24 which extends transversely to the belt line 14 of the vehicle body 12 in its active position, illustrated in FIG. 1, and is upwardly erect and can be pivoted from the active position illustrated in FIG. 1 by solid lines into an inactive position illustrated in FIG. 1 by dashed lines.

For this purpose, the wind blocker 24 is mounted on a front part 23 of the base part 22 facing the passenger compartment 18 so as to be pivotable about an axis 25.

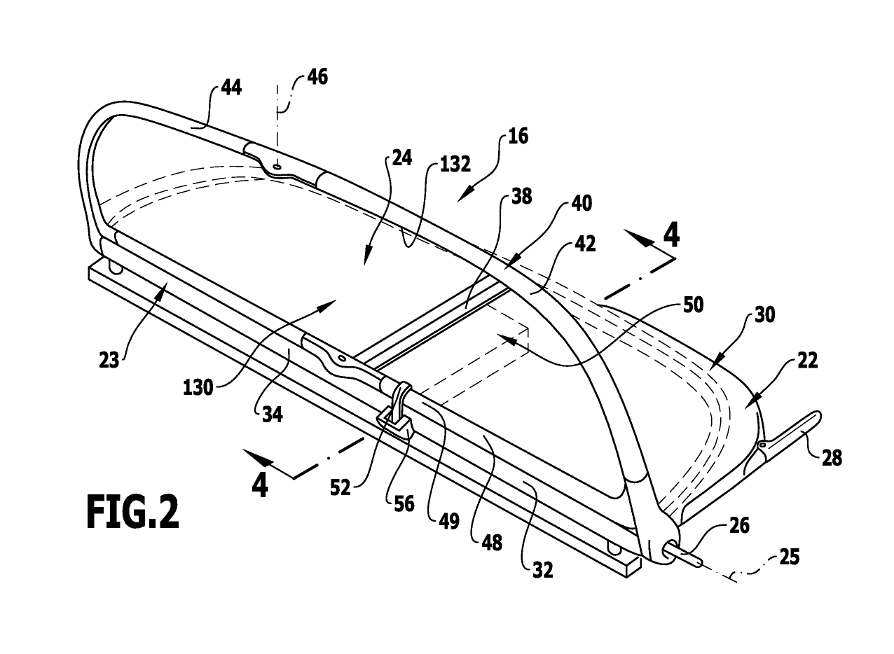

Such a wind stop device 16 can, as illustrated in FIG. 2, be mounted on the vehicle body 12 with the base part 22 via fixing elements 26 and 28 and, as a result, also be fixed to it.

The base part 22 is designed, for example, as a cover and comprises a cover frame which is designated as a whole as 30 and is formed, for example, from two cover frame parts 32 and 34, wherein the cover frame parts 32 and 34 can be folded relative to one another and can be fixed relative to one another in an outspread position illustrated in FIG. 2 so that front bars 36 thereof are essentially aligned to as to be flush with one another.

The wind blocker designated as a whole as 24 is held on the base part 22 and has a wind blocker frame 40 which is likewise formed from two wind blocker frame parts 42 and 44 which can be folded relative to one another about an axis 46.

The wind blocker frame parts 42 and 44 can also be fixed relative to one another in the outspread position illustrated in FIG. 2 and form a continuous lower frame bar 48.

In order to be able to pivot the wind blocker 24 with the wind blocker frame 40 from the active position illustrated in FIG. 2 by solid lines into the inactive position illustrated in FIG. 2 by dashed lines, a drive unit 50 is held on the base part 22, for example, the cover frame part 32 and acts on the wind blocker frame 40 with a displacing element 52, which is tensilely rigid but bendable in a direction transverse to its direction of extension in a spring elastic manner and is, therefore, inherently rigid only to a limited extent, in that, for example, the displacing element 52, for example, a strip consisting of spring steel engages on the lower frame bar 48, namely on an upper side 49 of the lower frame bar 48 which faces away from the vehicle body 12 in the active position of the wind blocker frame 40.

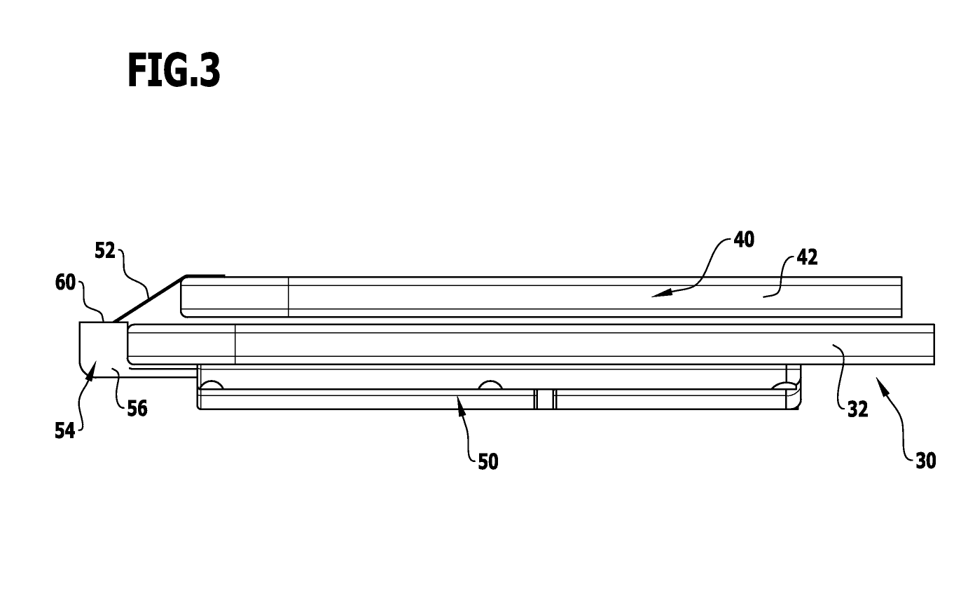

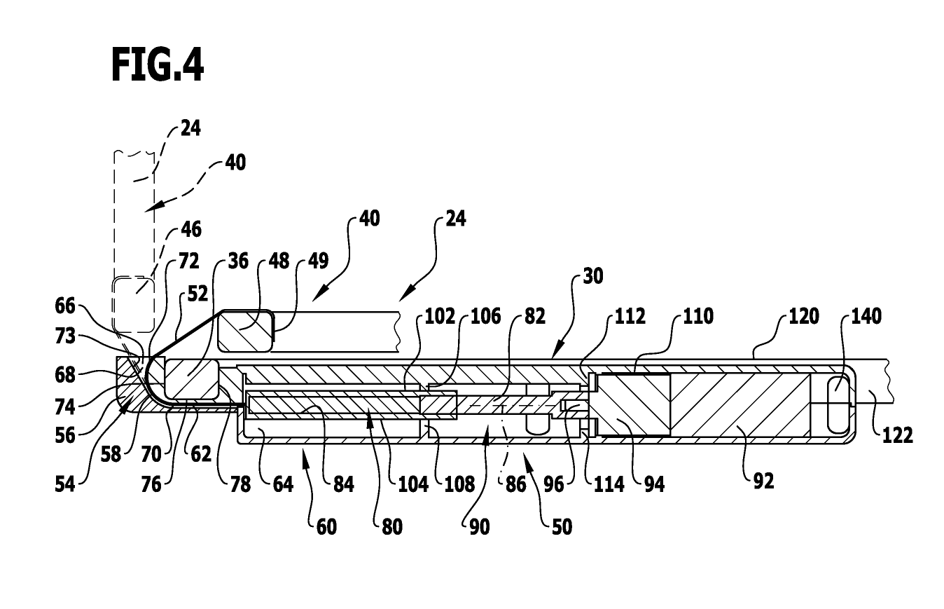

The drive unit 50 comprises, as illustrated in FIGS. 3 and 4, a guide 54 for the displacing element 52 which is arranged in a front area and is arranged in a part 56 of the housing 60 of the drive unit 50, wherein the guide 54 has a guide channel 62 which extends on a side of the front bar 36 of the cover frame 30 which faces the vehicle body 12 and is then bent away from the vehicle body 12 upwards in the direction of the wind blocker 24, namely from an interior space 64 of the housing 60 as far as an exit opening 66 which is located on a side facing away from the vehicle body 12 and from which the displacing element 52 exits. The guide channel 62 has, proceeding from the exit opening 66, a funnel-shaped area 68 which is followed by an area 70 which is adapted to a shape of the displacing element 52 and leads as far as the interior space 64.

In the guide 54, the displacing element 52 is deflected in such a manner that it has a section 58 extending in a curved manner and at the same this section 58 of the displacing element 52 which extends in a curved manner is guided and supported in such a manner that the displacing element can act on the wind blocker 24 not only with pulling forces but also with pressure forces in order to pivot it.

An inner arched guiding surface 72 extends on a side of the funnel-shaped area 68 facing the front bar 36 of the cover frame 30 and the displacing element 52 abuts on this guiding surface when the wind blocker frame 40 is in its inactive position and is intended to be moved from this position into the active position by way of pulling forces acting on the displacing element 52, wherein as a result of the guiding surface 72 as a whole the displacing element 52 is guided around an angle of more than 90°, preferably around an angle of more then 140°.

An outer guiding surface 73 is arranged opposite the inner guiding surface 72 and this supports the displacing element 52 when the wind blocker 24 is intended to be moved from the active position into the inactive position as a result of pushing forces acting on the displacing element 52.

The part 56 of the housing 60 accommodating the guide 54 engages around the front bar 36 of the cover frame 30, for example, in the area of its front side 74, its underside 76 and its rear side 78 and so, as a result, the guide 54 can be fixed in a form locking manner on the front bar 36.

The displacing element 52 entering the interior space 64 of the housing 60 via the guide channel 62 is connected in the interior space 64 of the housing 60 to a displacing unit, which is designated as a whole as 80, of a displacing device 90 which is arranged in the housing 60 and comprises, in addition to the displacing unit 80, a drive motor 92 with a gear unit 94.

The gear unit 94 with its driven shaft 96 drives the displacing unit 80 which, for its part, comprises a threaded spindle 82 driven by the driven shaft 96 as well as a spindle nut sleeve 84, wherein the threaded spindle 82 can be screwed into the spindle nut sleeve 84 so that the spindle nut sleeve 84 can be displaced along an axis of rotation 86 of the threaded spindle 82.

The displacing element 52 is connected to the spindle nut sleeve 84 on a side facing away from the threaded spindle 82 and so displacement of the spindle nut sleeve 84 away from the guide 54 leads to the displacing element 52 being drawn into the interior space 64 of the housing 60, wherein the displacing element 52 will be drawn through the guide 54 and is, in this case, in a position to pull the wind blocker frame 40 upright from the inactive position illustrated in FIG. 4 by solid lines into the active position illustrated in FIG. 4 by dashed lines.

For the guidance of the spindle nut sleeve 84 in a manner non-rotatable but displaceable in the direction of the axis of rotation 86 of the threaded spindle 82, the sleeve is provided, for example, with an non-round outer contour, for example, with flat sides 102 and 104 which are located opposite one another and abut on strips 106 and 108 of the housing 60 which are located opposite one another and therefore prevent the spindle nut sleeve 84 from rotating about the axis of rotation 86 with the threaded spindle 82.

As a result, the spindle nut sleeve 84 is mounted so as to be non-rotatable but displaceable in the direction of the axis of rotation 86.

The forces acting on the threaded spindle 82 when the threaded spindle 82 is screwed into the spindle nut sleeve 84 and, therefore, when the displacing element 52 is drawn into the interior space 64 of the housing 60 are preferably transferred from it via the driven shaft to the gear unit 94 which is supported with a gear unit housing 110 on supporting strips 112 and 114 of the housing 60 against any movement in the direction of the spindle nut sleeve 84 and, therefore, transfers to the housing 60 the forces acting on the displacing unit 80 when the displacing element 52 is drawn in.

If the threaded spindle 82 is, however, turned such that it is screwed out of the spindle nut sleeve 84, the spindle nut sleeve 84 migrates in the direction of the guide 54 and, therefore, pushes the displacing element 52, supported on the guiding surface 73, through the guide channel 62 in the direction of the lower bar 46 of the wind blocker frame 40 and so, on account of the limited inherent rigidity of the displacing element 52 and the support thereof on the guiding surface 73 of the guide 54, the upright wind blocker frame 40 illustrated in FIG. 4 by dashed lines experiences a pushing force exerted by the displacing element 52 at the upper side 49 of the frame bar 48 in the direction of a movement into the inactive position and this force pivots the wind blocker frame again from the active position illustrated by dashed lines in the direction towards the inactive position illustrated in FIG. 4 by solid lines so that the wind blocker 24 again reaches the inactive position.

The housing 60 of the drive unit 50 is located, for example, within the cover frame part 32 and is fixed by means of the part 56 accommodating the guide 54 not only on the front bar 36 of the cover frame 30 but also, for example, in addition, to a central bar 38 of the cover frame part 32.

Furthermore, the housing 60 is preferably located beneath a flat material 120 which closes the cover frame parts 32 and 34 in the area of a frame opening 122 so that the housing 60 is covered by the flat material 120 in a plan view of the cover frame 30 from a side facing away from the vehicle body 12.

The flat material 120 is preferably partially permeable to air, in the same way as a flat material 130 which closes a frame opening 132 of the wind blocker frame 40.

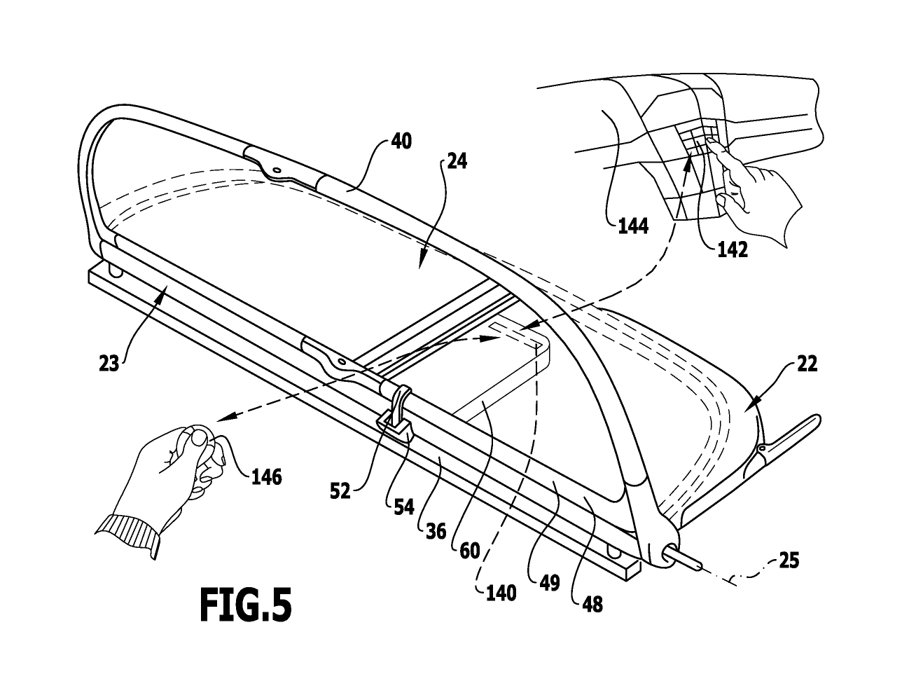

The activation of the electric drive motor 92 of the drive unit 50 is preferably brought about via a control circuit 140 which is integrated in the housing 60 and, as illustrated in FIG. 5, can either be activated, for example, in a line conducted manner by switch elements 142 on an instrument panel 144 of the vehicle body 12 or wirelessly by way of an operating unit 146 which can be taken along and actuated by an operator.

The various ways for activating the drive unit 50 are described in German patent application DE 10 2006 043 004 A, to which reference is made in full in this connection.

In addition, various types of current supply to the drive unit 50 are possible and are described in German patent application DE 10 2006 043 626 A, to which reference is likewise made in full.

1. Drive unit for a wind stop device for convertible vehicles, comprising a base part adapted to be mounted on a vehicle body and a wind blocker pivotable relative to the base part between an active upright position and an inactive position folded towards the back, wherein the drive unit serves the purpose of pivoting the wind blocker between the active position and the inactive position,
the drive unit comprising a displacing device and a displacing element tensilely rigid in its direction of extension and movable transversely to the direction of extension, said displacing element coupling the displacing device to the wind blocker for pivoting the wind blocker between the active position and the inactive position and having for this purpose a section extending in a curved manner at least in one position of the wind blocker.

2. Drive unit as defined in claim 1, wherein the displacing element is designed as an element movable transversely to its direction of extension in a spring elastic manner.

3. Drive unit as defined in claim 2, wherein the displacing element is designed as a strand of metal.

4. Drive unit as defined in claim 1, wherein the displacing element is connectable directly to the wind blocker.

5. Drive unit as defined in claim 4, wherein the displacing element is connectable to a lower frame bar of a wind blocker frame of the wind blocker.

6. Drive unit as defined in claim 1, wherein the section of the displacing element extending in a curved manner is guided by means of a guide.

7. Drive unit as defined in claim 6, wherein the guide has a guide channel extending in a curved manner.

8. Drive unit as defined in claim 7, wherein the guide channel permits varying curvatures for the section of the displacing element guided in it.

9. Drive unit as defined in claim 8, wherein the guide channel has a funnel-shaped area permitting movement of the displacing element transversely to its direction of extension.

10. Drive unit as defined in claim 7, wherein the guide channel has a curved guiding surface on at least one side.

11. Drive unit as defined in claim 10, wherein the displacing element abuts on the curved guiding surface over a greater length when the wind blocker is in one position than in the other position of the wind blocker.

12. Drive unit as defined in claim 7, wherein the guide channel has a curved outer guiding surface and a curved inner guiding surface.

13. Drive unit as defined in claim 7, wherein the guide has a guide channel with an area guiding the displacing element free from transverse movement.

14. Drive unit as defined in claim 1, wherein the displacing device comprises a displacing unit adapted to be driven for rotation.

15. Drive unit as defined in claim 14, wherein the displacing unit acts linearly on the displacing element.

16. Drive unit as defined in claim 14, wherein the displacing unit comprises a threaded spindle and a spindle nut.

17. Drive unit as defined in claim 1, wherein the threaded spindle is adapted to be driven by a drive motor.

18. Drive unit as defined in claim 1, wherein the drive unit is adapted to be mounted on the base part.

19. Drive unit as defined in claim 18, wherein the drive unit has a housing adapted to be mounted on the base part.

20. Drive unit as defined in claim 19, wherein the housing is adapted to be mounted on a front part of the base part.

21. Drive unit as defined in claim 18, wherein the housing is adapted to be mounted on the base part with a part accommodating the guide.

22. Drive unit as defined in claim 20, wherein the housing engages partially around a front bar of the base part.

23. Drive unit as defined in claim 21, wherein the guide guides the displacing element partially around the front bar of the base part.

24. Drive unit as defined in claim 18, wherein the drive unit is adapted to be mounted on an underside of the base part.

25. Drive unit as defined in claim 24, wherein the housing is adapted to be mounted on the front bar of the base part.

26. Wind stop device for convertible vehicles, comprising a base part adapted to be mounted on a vehicle body, a wind blocker pivotable relative to the base part between an active upright position and an inactive position folded towards the back as well as a drive unit for pivoting the wind blocker between the active position and the inactive position, wherein the drive unit is designed in accordance with claim 1.
